(19) United States
(12) Patent Application Publication
(10) Pub. No.: US 2025/0003787 A1
(43) Pub. Date: Jan. 2, 2025

(54) ENGINE DRIVEN WELDING-TYPE POWER SUPPLIES WITH REFUELING DETECTION SYSTEMS

(71) Applicant: Illinois Tool Works Inc., Glenview, IL (US)

(72) Inventor: Jeffery R. Ihde, Greenville, WI (US)

(21) Appl. No.: 18/744,940

(22) Filed: Jun. 17, 2024

Related U.S. Application Data
(60) Provisional application No. 63/524,041, filed on Jun. 29, 2023.

(51) Int. Cl. G01F 23/80; B23K 9/10

(52) U.S. Cl. CPC G01F 23/802; B23K 9/1006

(57) ABSTRACT

Described herein are examples of welding-type power supplies with refueling detection systems that use provide user perceptible outputs from refueling output devices proximate the fuel tank (and/or fuel tank inlet), so that the output can be perceived by the operator when refueling. The outputs may indicate how much fuel is in the fuel tank, and/or whether the fuel tank has been filled to capacity, so the operator knows when to stop refueling. The refueling detection system is additionally configured to operate even when the power supply is turned off, in case the power supply is turned off prior to refueling (as is the best practice).

### CROSS REFERENCE TO RELATED APPLICATIONS

This application claims priority to, and the benefit of, U.S. Provisional Application No. 63/524,041, entitled “Engine Driven Welding-Type Power Supplies with Refueling Detection Systems,” filed Jun. 29, 2023, the entire contents of which being hereby incorporated by reference.

### TECHNICAL FIELD

The present disclosure generally relates to welding-type power supplies, and more particularly to engine driven welding-type power supplies with refueling detection systems.

### BACKGROUND

Some welding-type power supplies use engines to generate electrical power for welding-type operations. As the engines require a constant supply of fuel to operate, some engine driven welding-type power supplies also include fuel tanks that hold fuel for use by the engines. When the fuel in the fuel tank is depleted, the fuel tank must be refilled.

Limitations and disadvantages of conventional and traditional approaches will become apparent to one of skill in the art, through comparison of such systems with the present disclosure as set forth in the remainder of the present application with reference to the drawings.

### SUMMARY

The present disclosure is directed to engine driven welding-type power supplies with refueling detection systems, for example, substantially as illustrated by and/or described in connection with at least one of the figures, and as set forth more completely in the claims.

These and other advantages, aspects and novel features of the present disclosure, as well as details of an illustrated example thereof, will be more fully understood from the following description and drawings.

### BRIEF DESCRIPTION OF THE DRAWINGS

FIG. 1 illustrates an example of a welding-type system, in accordance with aspects of this disclosure.

FIG. 2 is a block diagram illustrating an example refueling detection system of the welding-type system of FIG. 1, in accordance with aspects of this disclosure.

FIG. 3 illustrates an example of how one or more fuel level sensors of the refueling detection system of FIG. 2 might be positioned relative to a fuel tank of the welding-type system of FIG. 1, in accordance with aspects of this disclosure.

FIG. 4 is a diagram of an example on/off circuit of the welding-type system of FIG. 1, in accordance with aspects of this disclosure.

FIG. 5 is a flow diagram illustrating an example refueling detection process of the refueling detection system of FIG. 2, in accordance with aspects of this disclosure.

The figures are not necessarily to scale. Where appropriate, similar or identical reference numerals are used to refer to similar or identical components. For example, reference numerals utilizing lettering (e.g., controllable circuit element 402a, controllable circuit element 402b) refer to instances of the same reference numeral that does not have the lettering (e.g., controllable circuit elements 402).

### DETAILED DESCRIPTION

While some existing engine driven welding-type power supplies have fuel gauges on the front panel of the power supply, the fuel tank itself (and the fuel tank inlet) is often positioned closer to the rear and/or side of the power supply. Thus, an operator is often positioned to the side or rear of the power supply when refueling the fuel tank. In such a position the front panel fuel gauge is not easily visible. Lack of visibility may result in under filling or over filling the fuel tank, either of which may cause problems (e.g., spillage, running problems, etc.). Additionally, best practice for power supply refueling involves turning off the power supply for refueling, which results in the front panel fuel gauge (and/or associated sensors) being turned off as well. As the front panel fuel gauge will likely be off when refueling, even if the operator could see the fuel gauge on the front panel of the power supply when refueling, the fuel gauge would be inoperative and unhelpful.

Some examples of the present disclosure relate to refueling detection systems having output devices positioned proximate the fuel tank inlet that receive power even when the power supply is turned off. In some examples, a refueling detection system may use one or more refueling sensors to detect when a fuel tank is being refueled, and/or determine the volume (and/or level) of fuel in the fuel tank. The refueling detection system may use one or more of the output devices positioned proximate the fuel tank to provide an indication of the fuel level to the operator, so that the operator can be aware of how full the fuel tank is, and/or when/whether the fuel tank has been filled to capacity.

Some examples of the present disclosure relate to an engine driven power supply, comprising: a fuel tank configured to store a volume of fuel; an engine-generator configured to use the fuel stored in the fuel tank to generate electrical power; an energy storage device configured to output stored power; a refueling detection system that receives the stored power from the energy storage device even when the engine driven power supply is powered off, the powered off refueling detection system comprising: a fuel level sensor configured to detect fuel level sensor data indicative of the volume of the fuel within the fuel tank, control circuitry configured to receive the fuel level sensor data from the fuel level sensor, and determine the volume of the fuel in the fuel tank based on the fuel level sensor data, and an output device configured to provide a perceptible output indicative of the volume of the fuel in the fuel tank.

In some examples, the fuel level sensor is configured to operate in a lower power mode, where the fuel level sensor data is detected at a lower sampling rate, and the fuel level sensor is configured to switch to operation in a higher power mode, where the fuel level sensor data is detected at a higher sampling rate, in response to being activated by the control circuitry. In some examples, the control circuitry is configured to activate the fuel level sensor in response to determining, based on the fuel level sensor data, that that fuel tank is being refueled. In some examples, the refueling detection system further comprises a refueling sensor configured to detect when the fuel tank is being refueled, the control circuitry being configured to activate the fuel level sensor in response to the refueling sensor detecting the fuel tank is being refueled.

In some examples, the fuel level sensor is configured to return to operation in the lower power mode a threshold time period after the control circuitry determines that (i) the fuel tank is no longer being refueled, or (ii) the volume of the fuel within the fuel tank has reached a threshold level. In some examples, (i) the fuel level sensor comprises an optical sensor, a float sensor, a moisture sensor, an acoustic sensor, a depth sensor, a distance sensor, weight sensor, or a proximity sensor, (ii) the fuel level sensor is positioned in or on a neck of the fuel tank, or (iii) the output device is configured to provide the perceptible output in response to the volume of the fuel in the fuel tank reaching a threshold level. In some examples, the output device comprises a first output device, the engine driven power supply further comprising a second output device comprising an electrical fuel gauge, the second output device receiving stored power from the energy storage device only when the engine driven power supply is powered on.

In some examples, the engine driven welding power supply further comprises a housing enclosing the power conversion circuitry and the energy storage device, the housing comprising a front panel, a rear panel, and a side panel connecting the front and rear panel, the second output device being positioned on or in the front panel of the housing, and the first output device not being positioned on or in the front panel of the housing. In some examples, the second output device is part of a circuit that comprises the second output device, the energy storage device, and a power switch. In some examples, the engine driven welding power supply further comprises a power switch interface configured to receive user input, and open or close the power switch in response to the user input, wherein the circuit is complete, and the second output device is powered by the stored power, when the power switch is closed, and the circuit is broken, and the second output device is unpowered, when the power switch is open.

Some examples of the present disclosure relate to an engine driven welding-type power supply, comprising: a fuel tank configured to store a volume of fuel; an engine-generator configured to use the fuel stored in the fuel tank to generate electrical power; power conversion circuitry configured to receive the electrical power from the generator as input power and convert the input power to welding-type output power based on one or more control signals; an energy storage device configured to output stored power; a refueling detection system that receives the stored power from the energy storage device even when the engine driven power supply is powered off, the powered off refueling detection system comprising: a fuel level sensor configured to detect fuel level sensor data indicative of the volume of the fuel within the fuel tank, control circuitry configured to receive the fuel level sensor data from the fuel level sensor, and determine the volume of the fuel in the fuel tank based on the fuel level sensor data, and an output device configured to provide a perceptible output indicative of the volume of the fuel in the fuel tank.

In some examples, the fuel level sensor is configured to operate in a lower power mode, where the fuel level sensor data is detected at a lower sampling rate, and the fuel level sensor is configured to switch to operation in a higher power mode, where the fuel level sensor data is detected at a higher sampling rate, in response to being activated by the control circuitry. In some examples, the control circuitry is configured to activate the fuel level sensor in response to determining, based on the fuel level sensor data, that that fuel tank is being refueled. In some examples, the refueling detection system further comprises a refueling sensor configured to detect when the fuel tank is being refueled, the control circuitry being configured to activate the fuel level sensor in response to the refueling sensor detecting the fuel tank is being refueled.

In some examples, the fuel level sensor is configured to return to operation in the lower power mode a threshold time period after the control circuitry determines that (i) the fuel tank is no longer being refueled, or (ii) the volume of the fuel within the fuel tank has reached a threshold level. In some examples, (i) the fuel level sensor comprises an optical sensor, a float sensor, a moisture sensor, an acoustic sensor, a depth sensor, a distance sensor, weight sensor, or a proximity sensor, (ii) the fuel level sensor is positioned in or on a neck of the fuel tank, or (iii) the output device is configured to provide the perceptible output in response to the volume of the fuel in the fuel tank reaching a threshold level. In some examples, the output device comprises a first output device, the engine driven power supply further comprising a second output device comprising an electrical fuel gauge, the second output device receiving stored power from the energy storage device only when the engine driven power supply is powered on.

In some examples, the engine driven welding power supply further comprises an electrical socket and a housing, the electrical socket being in electrical communication with the power conversion circuitry and configured for connection with an electrical cable that will route the output power to a welding-type tool or welding-type equipment, the housing enclosing the power conversion circuitry and the energy storage device, the housing comprising a front panel, a rear panel, and a side panel connecting the front and rear panel, the electrical socket and the second output device being positioned on or in the front panel of the housing, and the first output device not being positioned on or in the front panel of the housing. In some examples, the second output device is part of a circuit that comprises the second output device, the energy storage device, and a power switch. In some examples, the engine driven welding power supply further comprises a power switch interface configured to receive user input, and open or close the power switch in response to the user input, wherein the circuit is complete, and the second output device is powered by the stored power, when the power switch is closed, and the circuit is broken, and the second output device is unpowered, when the power switch is open.

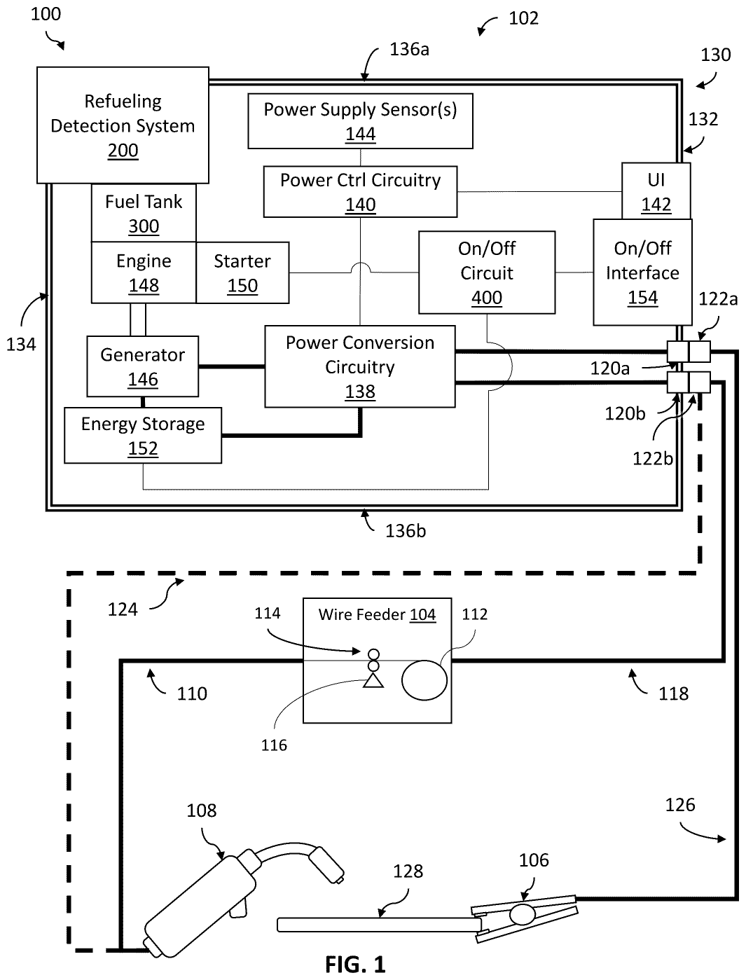

FIG. 1 shows an example engine-driven welding-type system 100. It should be appreciated that, while the example welding-type system 100 shown in FIG. 1 may be described as a gas metal arc welding (GMAW) system, the presently disclosed system 100 may also be used with other arc welding processes (e.g., flux-cored arc welding (FCAW), gas shielded flux-cored arc welding (FCAW-G), gas tungsten arc welding (GTAW), submerged arc welding (SAW), shielded metal arc welding (SMAW), or similar arc welding processes) or other metal fabrication systems, such as plasma cutting systems, induction heating systems, and so forth. In some examples, the disclosure may also be applied outside of welding-type systems.

In the example of FIG. 1, the welding-type system 100 includes a welding-type power supply 102, a wire feeder 104, a clamp 106, and a tool 108. In the example of FIG. 1, the tool 108 is shown as being a welding-type tool, such as, for example, a welding torch or plasma cutter. In some examples, the tool 108 may be a different type of tool, such as, for example, an air pump, air compressor, or hydraulic pump.

In the example of FIG. 1, the tool 108 is connected to the wire feeder 104 via feeder cable 110. In the example of FIG. 1, the wire feeder 104 houses a wire spool 112 that is used to provide the tool 108 with a wire electrode (e.g., solid wire, cored wire, coated wire). In the example of FIG. 1, the wire feeder 104 further includes rollers 114 configured to feed the wire electrode to the tool 108 (e.g., from the spool 112) and/or retract the wire electrode from the tool 108 (e.g., back to the spool 112). As shown, the wire feeder 104 further includes a motor 116 configured to turn one or more of the rollers 114, so as to feed the wire electrode to the tool 108 via the feeder cable 110.

In the example of FIG. 1, the wire feeder 104 is connected to the welding-type power supply 102 via power cable 118. As shown, the power cable 118 is connected to a power socket 120 of the welding-type power supply 102 via a power plug 122 at the end of the power cable 118. While not specifically labeled, in some examples, the welding wire feeder 104 may include one or more sockets and/or plugs as well. In some examples, the wire feeder 104 may route power received from the welding-type power supply 102 (e.g., via power cable 118) to the tool 108 (e.g., via feeder cable 110) along with the wire electrode.

In the example of FIG. 1, the tool 108 is also shown directly connected to the welding-type power supply 102 via dotted line 124 to indicate that, in some examples, the tool 108 may be directly connected to the power supply 102, rather than connected through the wire feeder 104. For example, the wire feeder 104 may be integrated into the power supply 102, such that there is no need for the power supply 102 to connect to the tool 108 through the wire feeder 104. As another example, the wire feeder 104 may be omitted from the system 100 entirely.

In the example of FIG. 1, the welding-type power supply 102 is further coupled to a ground clamp 106 through ground cable 126. The ground clamp 106 holds a workpiece 128 that may be worked upon during a welding-type operation. In some examples, the workpiece 128 and tool 108 (and/or wire electrode) may form a circuit by way of their electrical connection to the welding-type power supply 102. The circuit formed from the workpiece 128 and tool 108 (and/or wire electrode) may be open until closed and/or completed by a welding arc. In some examples, a welding arc is formed between the tool 108 (and/or wire electrode) and the workpiece 128 using power from the welding-type power supply 102 when a welding-type process is initiated (e.g., via activation of a trigger of the tool 108).

In the example of FIG. 1, the welding-type power supply 102 includes a housing 130. In the example of FIG. 1, the power supply 102 is shown from a top down perspective, such that the front panel 132, rear panel 134, and side panels 136 of the housing 130 are shown (e.g., with no roof). As shown, many of the components of the welding-type power supply 102 are enclosed within the housing 130. Some of the components of the welding-type power supply 102 (e.g., sockets 120) are shown as extending across the housing 130, indicating that the component(s) may be positioned in, on, and/or extending beyond the housing 130.

In the example of FIG. 1, the welding-type power supply 102 supplies power to the tool 108, wire electrode, and/or ground clamp 106 through the sockets 120 in/on the front panel 132 of the housing 130 of the welding-type power supply 102. In some examples, the power provided through the sockets 120 may be welding-type output power. In some examples, the power provided through the sockets 120 may be auxiliary power (e.g., in addition to welding-type output power.

As shown, the sockets 120 on the front panel 132 of the housing 130 of the welding-type power supply 102 are electrically connected to power conversion circuitry 138 of the welding-type power supply 102. In some examples, the power conversion circuitry 138 is configured to convert input power to output power (e.g., welding-type output power, auxiliary output power, and/or other power). In some examples, the power conversion circuitry 138 may include circuit elements (e.g., transformers, rectifiers, capacitors, inductors, diodes, transistors, switches, and so forth) capable of converting the input power to output power.

In some examples, the power conversion circuitry 138 may include one or more controllable circuit elements. In some examples, the controllable circuit elements may comprise circuitry configured to change states (e.g., fire, trigger, turn on/off, close/open, etc.) based on one or more control signals. In some examples, the state(s) of the controllable circuit elements may impact the operation of the power conversion circuitry 138, and/or impact characteristics (e.g., current/voltage magnitude, frequency, waveform, etc.) of the output power provided by the power conversion circuitry 138. In some examples, the controllable circuit elements may comprise, for example, switches, relays, transistors, etc. In examples where the controllable circuit elements 204 comprise transistors, the transistors may comprise any suitable transistors, such as, for example MOSFETs, JFETs, IGBTs, BJTs, etc.

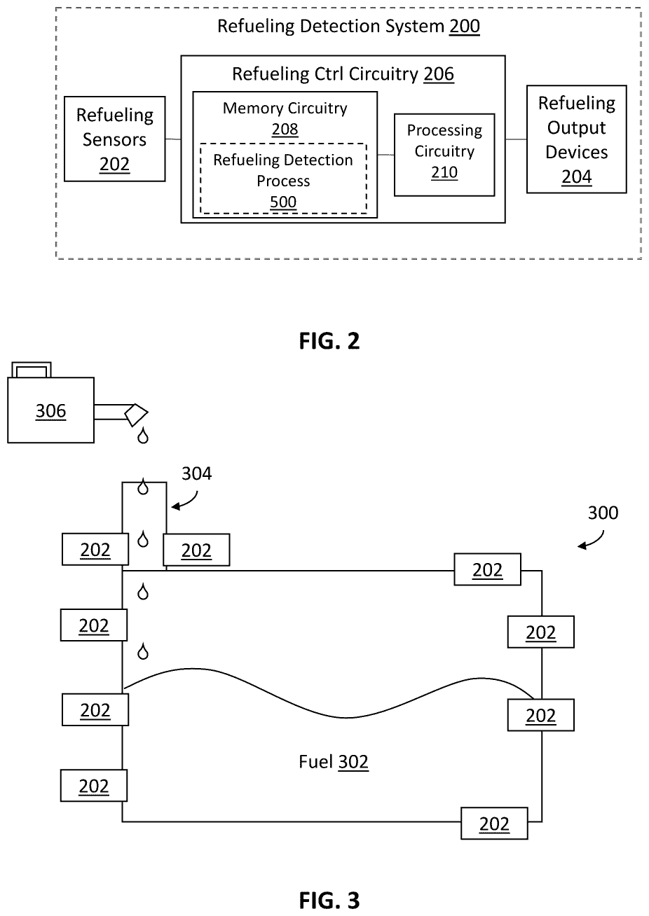

In the examples of FIG. 2, the welding-type power supply 102 includes power control circuitry 140 electrically coupled to the power conversion circuitry 138. In some examples, the controllable circuit elements of the power conversion circuitry 138 may be controlled by (and/or receive control signals from) the power control circuitry 140 of the welding-type power supply 102. In some examples, the power control circuitry 140 operates to control the power conversion circuitry 138, so as to ensure the power conversion circuitry 138 generates the appropriate output power.

In some examples, the power control circuitry 140 comprises processing circuitry (e.g., in the form of one or more processor) and/or memory circuitry. In some examples, the processing circuitry may use data stored in the memory circuitry to execute control algorithms to control the power conversion circuitry 138. In some examples, the power control circuitry 140 may control the power conversion circuitry based on weld parameters (e.g., target voltage/current), welding processes, and/or other weld settings input programmatically and/or input by an operator via a user interface (UI) 142 of the power supply 102.

In some examples, the welding-type system 100 may receive weld settings from the operator via the UI 142. In the example of FIG. 1, the UI 142 is positioned on the front panel 132 of the housing 104, proximate the sockets 120. In some examples, the UI 142 may include one or more input devices and/or output devices. In some examples, input devices may include switches, knobs, levers, buttons, touch screens, microphones, and/or other output devices. In some examples, output devices may include display screens, gauges (e.g., a fuel gauge), speakers, lights, and/or other output devices.

In the example of FIG. 1, the UI 142 is coupled to the power control circuitry 140. In some examples, the UI 142 may communicate the weld settings/parameters to the power control circuitry 140 via this coupling. In some examples, the UI 142 may additionally receive (e.g., sensor) data from the power control circuitry 140 via the coupling with the power control circuitry 140.

In the example of FIGS. 1 and 2, the welding-type system 100 includes one or more power supply sensors 144 connected to the power control circuitry 140. In some examples, the power supply sensors 144 may include one or more sensors configured to detect a volume and/or level of fuel 302 within a fuel tank 300 of the power supply (see, e.g., FIG. 3), as discussed below. In some examples, the power supply sensors 144 may include one or more (e.g., voltage/current) feedback sensors. In some examples, the power control circuitry 140 may use feedback from the power supply sensor(s) 144 to control the conversion of input power to output power by the power conversion circuitry 138.

In the example of FIG. 1, the power conversion circuitry 138 receives input power from a generator 146 of the welding-type power supply 102. As shown, the generator 146 is electrically connected to the power conversion circuitry 138. In some examples, the generator 146 may generate electrical power that may be delivered to the power conversion circuitry 138 as input power through the electrical connection between the power conversion circuitry 138 and generator 146.

In some examples, the generator 146 may generate the electrical power (e.g., via a stator of the generator 146) from mechanical motion produced by an engine 148 of the power supply 102 (e.g., via the rotor of the engine 148). In some examples, the engine 148 may be a combustion engine 148. As the engine 148 and generator 146 work together to produce the electrical power, in some examples, the term engine-generator may be used as a shorthand to refer collectively to the engine 148 and generator 146.

In some examples, the engine 148 may be off until started by an engine starter 150. In some examples, the engine 148 may started via the engine starter 150 using stored energy from an energy storage device 152 of the power supply 102. In some examples, the stored energy from the energy storage device 152 may be provided to the engine starter 150 in response to input received from the operator via an on/off interface 154 of the power supply 102.

In some examples, the on/off interface 154 may include one or more input devices (e.g., switches, knobs, levers, buttons, keys, key ignition barrels, etc.). In some examples, the state(s) (e.g., on/off, open/closed, etc.) of one or more controllable circuit elements 402 in the on/off circuit 400 may be changed in response to input received via the on/off interface 154. The change in state of the controllable circuit element(s) 402 in the on/off circuit 400 may allow or prevent the engine starter 150 to/from starting the engine 148 using stored energy from the energy storage device 152.

In some examples, the energy storage device 152 may store and/or output electrical energy and/or power for use by components of the welding-type power supply 102. In some examples, the energy storage device 152 may be a battery, fuel cell, or capacitor. In the example of FIG. 1 the energy storage device 152 is shown electrically connected to the generator 146 and power conversion circuitry 138.

In some examples, the energy storage device 152 may be recharged by electrical power generated by the generator 146 and/or power output by the power conversion circuitry 138. In some examples, the stored power output by the energy storage device 152 may be used by the engine starter 150 to start the engine 148. In some examples, the stored power output by the energy storage device 152 may be used by the engine 148 (e.g., via spark plugs) to keep the engine 148 going once started.

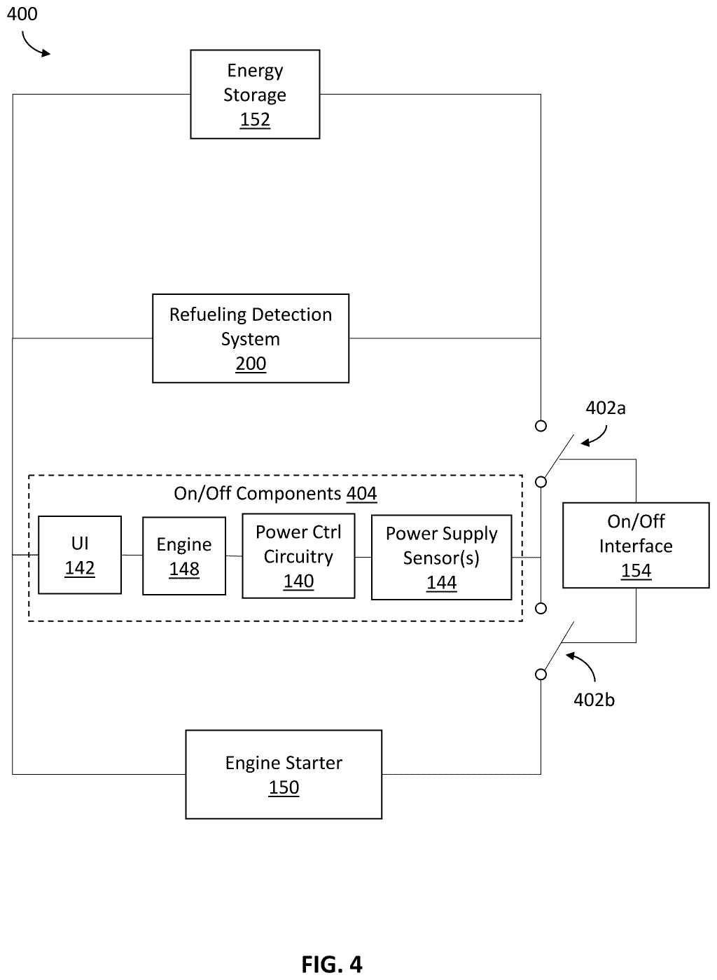

In the example of FIG. 1, the engine starter 150 is shown connected to the engine 148 and the on/off circuit 400. The on/off circuit 400 is in turn connected to the on/off interface 154 on the front panel 132 of the housing 130 of the power supply 102, as well as the energy storage device 152 of the power supply 102. While shown as only connecting to the on/off interface 154, engine starter 150, and energy storage device 152 in the example of FIG. 1 for the purposes of simplicity and clarity, and to illustrate the impact the on/off interface 154 and/or on/off circuit 400 may have on the operation of the engine starter 150 and/or energy storage device 152, in some examples, the on/off circuit 400 may impact other components of the welding-type power supply 102 as well (see, e.g., FIG. 4).

Once started, the engine 148 may use fuel 302 (e.g., see, e.g., FIG. 3) to produce the mechanical motion of the rotor, through which the generator 146 generates electrical power. In some examples, the engine 148 may further include one or more spark plugs to ignite the fuel 302 from the fuel tank 300 to keep the engine 148 going after the engine 148 has been started. In some examples, the fuel 302 may be petroleum based, such as, for example, diesel fuel or gasoline.

In the example of FIG. 1, the power supply 102 includes a fuel tank 300 is connected to the engine 148. In some examples, the fuel 302 used by the engine 148 may be stored in the fuel tank 300 until used. In some examples, the engine 148 may include a fuel pump to move fuel 302 from the fuel tank 300 to the engine 148 via the connection between the fuel tank 300 and engine 148.

As the fuel tank 300 is a finite size, the fuel tank 300 must be periodically refueled. In some examples, one or more of the power supply sensors 144 may be configured to detect how much fuel 302 is remaining in the fuel tank 300. The UI 142 in/on the front panel 132 may further provide an output indicative of the fuel 302 left in the fuel tank 300, so that an operator knows if/when it is time to replenish the supply of fuel 302.

However, in the example of FIG. 1, the fuel tank 300 (and/or the fuel tank inlet 304; see, e.g., FIG. 3) is closer to the rear panel 134 of the housing 130 than the front panel 132. Thus, the operator may need to position themselves closer to the rear panel 134 of the housing when refueling the fuel tank 300. In such a position, the UI 142 on the front panel 132 may not be easily visible. Lack of visibility may result in under filling or over filling the fuel tank 300, either of which may cause problems (e.g., spillage, running problems, unexpected shutdown, etc.). Additionally, best practices for refueling the power supply 102 calls for turning off the power supply 102 (e.g., via the on/off interface 154) prior to refueling, which results in the front panel fuel gauge (and/or associated fuel sensors) being turned off as well. Thus, even if the operator could see the fuel gauge on the front panel 132 of the power supply 102, the fuel gauge would likely be inoperative and unhelpful.

To address these issues, the welding-type power supply 102 shown in FIG. 1 includes a refueling detection system 200. As shown in FIG. 1, the refueling detection system 200 is positioned proximate the fuel tank 300 (e.g., in or on the rear panel 134 or side panel 136), such that an operator refueling the fuel tank 300 will be able to perceive (e.g., see, hear, feel, etc.) output of the refueling detection system 200 indicating a volume and/or level of the fuel 302 in the fuel tank 300. Additionally, the refueling detection system 200 is configured to operate even when the welding-type power supply 102 is turned off, so that an operator can be informed of the volume and/or level of the fuel 302 in the fuel tank 300 even if the welding-type power supply 102 is turned off before refueling.

FIG. 2 is a block diagram showing components of the refueling detection system 200. As shown, the refueling detection system 200 includes a plurality of refueling sensors 202, a plurality of refueling output devices 204, and refueling control circuitry 206. In some examples, one or more of the refueling sensors 202 may comprise an optical sensor, a float sensor, a moisture sensor, an acoustic sensor, an ultrasonic sensor, a depth sensor, a distance sensor, weight sensor, or a proximity sensor. In some examples, one or more of the refueling sensors 202 may be a power supply sensor 144.

In some examples, one or more of the refueling output devices 204 may comprise a display screen, speaker, or haptic device configured to provide an output that can be perceived (e.g., seen, heard, felt, etc.) by a human operator. In some examples, one or more of the refueling output devices 204 may be positioned on or in the rear panel 134 or side panel 136 of the housing 130, proximate to the fuel tank 300 (and/or a neck inlet 304 of the fuel tank 300; see, e.g., FIG. 3), so that an operator refueling the fuel tank 300 will be able to perceive (e.g., see, hear, feel, etc.) output of the refueling detection system 200 indicating a volume and/or level of the fuel 302 in the fuel tank 300.

As discussed above, the refueling detection system 200 is configured to operate even when the welding-type power supply 102 is turned off, so that an operator can be informed of the volume and/or level of the fuel 302 in the fuel tank 300 even if the welding-type power supply 102 is turned off before refueling. In some examples, this means that the components of the refueling detection system 200 will continue to receive stored electrical power from the energy storage device 152 even when none of the other components of the welding-type power supply 102 receive electrical power from the energy storage device 152 (e.g., because the power supply 102 has been turned off). In some examples, the components of the welding-type power supply 102 may receive, or stop receiving, electrical power from the energy storage device 152 as a result of the state (e.g., on/off, open/closed, etc.) of one or more controllable circuit elements 402 of the on/off circuit 400.

In some examples, one or more controllable circuit elements 402 of the on/off circuit 400 change state(s) (e.g., fire, turn on/off, close/open, etc.) in response to input from the on/off interface 154 (e.g., turning the power supply 102 on/off). Thus, in some examples, an operator may turn the power supply 102 off (and/or on) via the on/off interface 154, which may result in a change in state(s) of one or more controllable circuit elements 402 of the on/off circuit 400. A change in state of the controllable circuit element(s) 402 may, in turn, result in one or more components of the welding-type power supply 102 receiving, or no longer receiving, electrical power from the energy storage device 152.

FIG. 4 shows an example configuration of the on/off circuit 400. In the example of FIG. 4, the refueling detection system 200 forms one perpetually closed circuit with the energy storage device 152. In such a circuit the refueling detection will always receive stored electrical power from the energy storage device 152, so long as there remains electrical power stored by the energy storage device 152 that is available for output.

In the example of FIG. 4, the UI 142, engine 148, power supply sensor(s) 144, and power control circuitry 140 (collectively referred to hereinafter as on/off components 404) are shown connected in series with one another, and connected to the energy storage device 152 in parallel with the refueling detection system 200 and the engine starter 150. Additionally, there is a controllable circuit element 402a in the circuit 400 between the on/off components 404 and the energy storage device 152. Further, there is a controllable circuit element 402b in the circuit 400 between the on/off components and the engine starter 150.

In some examples, instead of being connected in series, the on/off components 404 may be connected in parallel with one another, so long as the controllable circuit element 402a lies between each on/off component 404 and the energy storage device 152, and the controllable circuit element 402b lies between each on/off component 404 and the engine starter 150. Regardless of whether the on/off components 404 are connected in series or parallel, the on/off components 404 are dependent upon the state of the controllable circuit element 402a for power. In particular, the circuit 400 is configured such that the state of the controllable circuit element 402a (and/or whether the controllable circuit element 402a completes/closes or breaks/opens the circuit 400 between the on/off components 404 and the energy storage device 152) controls whether the on/off components will receive stored electrical power from the energy storage device 152.

In the example of FIG. 4, the engine starter 150 is connected to the energy storage device 152 in parallel with the refueling detection system 200 and on/off components 404. As shown, two controllable circuit elements 402 (402a and 402b) are positioned in the circuit 400 between the engine starter 150 and the energy storage device 152. In this configuration, both controllable circuit elements 402 must be put into a state where they complete the circuit 400 before the engine starter 150 is able to receive stored electrical power from the energy storage device 152 and start the engine 148.

In some examples, each controllable circuit element 402 may comprise, for example, a switch, relay, and/or transistor (e.g., MOSFET, JFET, IGBT, BJT, etc.). In the example of FIG. 4, each controllable circuit element 402 is connected to and/or controlled by the on/off interface 154. In some examples, the controllable circuit element 402 may change state (e.g., fire, turn on/off, close/open, etc.) based on, and/or in response to one or more control signals sent by, and/or one or more mechanical actuations initiated by, the on/off interface 154.

While not shown, in some examples, the on/off interface 154 may be connected to the energy storage device 152 in a perpetually closed circuit configuration, similar to the configuration shown with respect to the refueling detection system 200. In such a configuration, the on/off interface 154 will always receive stored electrical power from the energy storage device 152, so long as there remains electrical power stored by the energy storage device 152 that is available for output. This may ensure that an operator can always turn on or off the on/off components 404 via control signals from the on/off interface 154. In some examples, the on/off interface 154 may be a purely mechanical (e.g., key) interface, such that no electrical power is required for operation.

In some examples, the control signals and/or mechanical actuations may be sent and/or initiated in response to operator input. For example, the controllable circuit element 402a may be a switch, and the operator may move (e.g., turn) a key (or ignition barrel, switch, slide, lever, etc.) of the on/off interface 154 into a first position that actuates/activates both controllable circuit elements 402 (e.g., switches) into open positions that break the circuit 400, thereby stopping stored electrical power from the energy storage device 152 from reaching the on/off components 404 and engine starter 150. In such a situation, the engine 148 and other on/off components 404 may lose power and/or shut off, and the power supply 102 may be considered to be off.

Further movement (e.g., turning) of the key into a second position may mechanically actuate the controllable circuit element 402a (e.g., switch) into a closed position that completes the circuit 400 and allows the on/off components 404 to receive stored electrical power from the energy storage device 152. In such a state, the engine 148 may continue to run (if already running), and the power supply sensors 144, power control circuitry 140, and the UI 142 (e.g., fuel gauge) may operate. Further movement (e.g., turning) of the key into a third position may mechanically actuate the controllable circuit element 402a and 402b into closed positions that complete the entire circuit 400 and allows both the on/off components 404 and engine starter 150 to receive stored electrical power from the energy storage device 152 (thereby allowing the engine 148 to start).

The lack of any controllable circuit element 402 between the refueling detection system 200 and the energy storage device 152 means that the refueling detection system 200 may continue to receive stored electrical power from the energy storage device 152, and thus continue to operate, even when the power supply 102 is turned off (e.g., via the on/off interface 154). While this may benefit the operator by allowing for output of a fuel level indication while the power supply 102 is off (as it should be when refueling), this also means that the refueling detection system 200 may be a continuous drain on the electrical power stored by the energy storage device 152. In order to minimize the continuous drain on the electrical power stored by the energy storage device 152, one or more components of the refueling detection system 200 may operate (and/or default to operation) in a lower power mode until refueling is detected.

In some examples, while in the lower power mode, a refueling sensor 202 may take samples and/or measurements, and/or send sensor data representative of samples/measurements to the refueling control circuitry 206, at a lower rate, so as to use less power. In some examples, while in the lower power mode, the refueling control circuitry 206 may operate slower and/or at a lower frequency, so as to use less power. In some examples, while in the lower power mode, the refueling output device(s) 204 may shut down and/or cease providing outputs.

In some examples, the refueling control circuitry 206 may activate the components of the refueling detection system 200 that are operating in lower power mode to transition the components to a higher power mode. In some examples, while in the higher power mode, a refueling sensor 202 may take samples and/or measurements, and/or send sensor data representative of the samples/measurements, at a higher rate than in the lower power mode. In some examples, while in the higher power mode, the refueling control circuitry 206 may operate faster and/or at a higher frequency than in the lower power mode. In some examples, while in the higher power mode, the refueling output device(s) 204 may power up and/or provide outputs.

In some examples, the refueling control circuitry 206 activate the higher power mode in response to determining that the fuel tank 300 is being refueled. In some examples, the determination may be based on an input from the UI 142 (e.g., before the power supply 102 is turned off) indicating that refueling is about to take place. In some examples, the determination may be based on sensor data from one or more of the refueling sensors 202.

In some examples, one or more of the refueling sensors 202 may be used to detect some condition indicative of refueling, from which the refueling control circuitry 206 may determine whether refueling is occurring. For example, one or more refueling sensors 202 might be acoustic sensors, and the refueling control circuitry 206 may be able to recognize sounds that correlate with refueling. As another example, one or more of the refueling sensors 202 might detect the level and/or volume of the fuel 302 in the fuel tank (e.g., by way of optical measurements, distance/depth/proximity measurements, a float sensor, etc.), and the refueling control circuitry 206 may determine refueling is occurring if the sensor data indicates the level and/or volume of the fuel 302 in the fuel tank 300 is increasing.

FIG. 3 show examples of how the refueling sensors 202 may be placed on, in, and/or around the fuel tank 300. As shown, refueling sensors 202 may be positioned proximate the neck inlet 304 of the fuel tank 300 to detect when the fuel tank 300 is full and/or being refueled. In some examples, fuel 302 is delivered to the fuel tank 300 through the neck inlet 304 during refueling. In some examples, the neck inlet 304 may have an opening in the housing 130 of the power supply 102, extend out of the (e.g., roof, rear panel 134, and/or side panel 136 of the) housing 130 of the power supply 102. In some examples, the neck inlet 304 may be accessible via a window (and/or through removal or movement) of a rear panel 134 or side panel 136 of the housing 130 of the power supply 102.

Refueling sensors 202 positioned proximate the neck inlet 304 may be able to detect when new fuel 302 is being poured into the fuel tank 300 (e.g., from a fuel can 306), and/or when the fuel tank 300 is full. For example, a pair of optical emitter/receiver refueling sensors 202 might report intermittent detection of (and/or optical interruption caused by) fuel 302 being poured into the fuel tank 300, from which the refueling control circuitry 206 may determine the fuel tank 300 is being refueled. As another example, a pair of optical emitter/receiver refueling sensors 202 might report continuous detection of (and/or optical interruption caused by) fuel 302 in the neck inlet 304, from which the refueling control circuitry 206 may determine the fuel tank 300 has been refilled to maximum capacity. As another example, a moisture refueling sensor 202 may detect an increase in moisture in the neck inlet 304, from which the refueling control circuitry 206 may determine the fuel tank 300 is being refueled, and/or that the volume/level of the fuel 302 is near the neck inlet 304.

Refueling sensors 202 may also be positioned proximate the top of the fuel tank 300, the bottom of the fuel tank, and/or the sides of the fuel tank (e.g., at various heights) to detect when the fuel tank 300 is full and/or being refueled. For example, a weight refueling sensor 202 positioned below the fuel tank 300 may detect a weight of the fuel tank 300, from which the refueling control circuitry 206 may determine the fuel tank 300 is being refueled (e.g., if the weight is increasing by more than a threshold amount/rate), and/or what the volume/level of the fuel 302 is in the fuel tank 300 (e.g., based on a known/stored weight of the fuel tank 300 when empty/full). As another example, a proximity/distance refueling sensor 202 positioned at the top of the fuel tank 300 may measure the proximity/distance to the fuel 302 in the fuel tank 300 (e.g., using ultrasonic waves), from which the refueling control circuitry 206 may determine the fuel tank 300 is being refueled (e.g., if the proximity/distance is decreasing by more than a threshold amount/rate), and/or what the volume/level of the fuel 302 is in the fuel tank 300 (e.g., based on a known/stored distance to the bottom of the fuel tank 300 when empty). As another example, pairs of optical emitter/receiver refueling sensors 202 might report continuous detection of (and/or optical interruption caused by) fuel 302 in the fuel tank 300, from which the refueling control circuitry 206 may determine the fuel 302 in the fuel tank 300 is at least at a particular level (e.g., corresponding to the placement of the refueling sensor(s) 202).

In the example of FIG. 2, the refueling control circuitry 206 includes memory circuitry 208 in electrical communication with processing circuitry 210. In some examples, the processing circuitry 210 may comprise one or more processors, controllers, and/or graphical processing units (GPUs). In some examples, the processing circuitry 210 may be configured to execute machine readable instructions stored in the memory circuitry 208.

In the example of FIG. 2, the memory circuitry 208 includes (and/or stores) a refueling detection process 500. In some examples, the refueling detection process 500 may comprise machine-readable instructions stored in memory circuitry 208 and/or configured for execution by the processing circuitry 210. In some examples, the refueling detection process 500 may be implemented via discrete circuitry (e.g., of the processing circuitry 210) rather than, or in addition to, instructions stored in the memory circuitry 208. While shown as being separate and distinct, in some examples, the refueling control circuitry 206 may be the same as, and/or share components with, the power control circuitry 140.

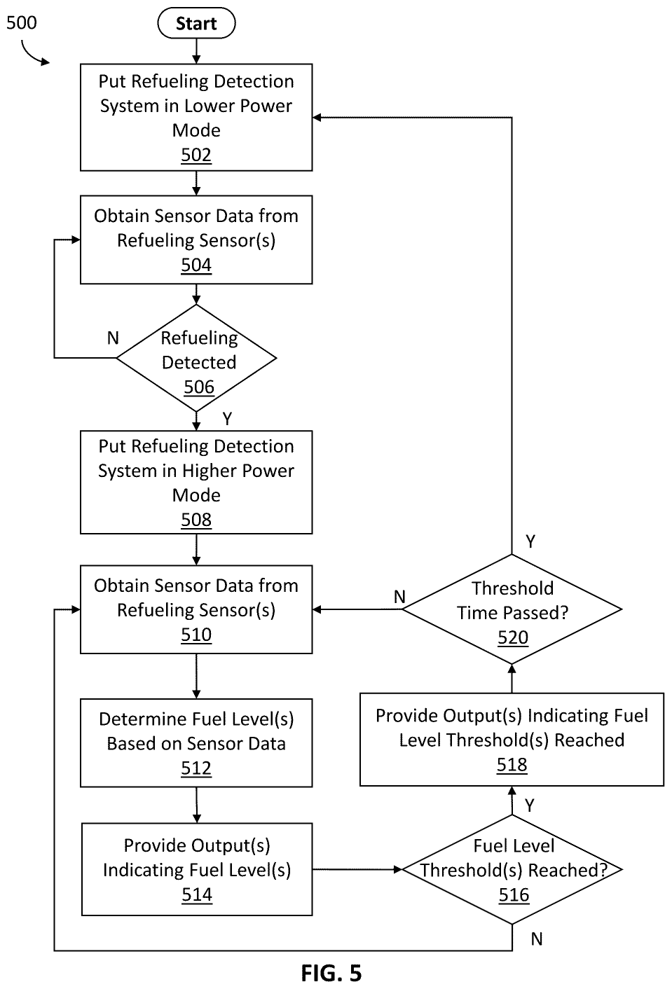

FIG. 5 is a flowchart illustrating operation of an example refueling detection process 500. In some examples, during the refueling detection process 500, the refueling control circuitry 206 may determine (e.g., from sensor data of the refueling sensor(s) 202) whether the fuel tank 300 is being refueled and/or how much fuel 302 is in the fuel tank 300. During the refueling detection process, the refueling output device(s) 204 may additionally provide one or more operator perceptible outputs indicative of the level and/or volume of fuel 302 in the fuel tank 300. While some of the disclosure below discusses the refueling detection process 500 performing certain actions, this should be understood as a shorthand for one or more components of the refueling detection system 200 (e.g., processing circuitry 210, refueling sensor(s) 202, etc.) performing the action(s) as part of the refueling detection process 500.

In the example of FIG. 5, the refueling detection process 500 begins by putting the refueling detection system 200 into a lower power mode at block 502, as discussed above. Then, sensor data representative of one or more measurements/detections/samples of the refueling sensor(s) 202 is obtained from one or more refueling sensors at block 504.

In some examples, only sensor data from the refueling sensor(s) 202 whose data may be used to determine whether the fuel tank 300 is being refueled may be obtained at block 504. In some examples, refueling sensors 202 that will be used to determine whether refueling is taking place may not be placed into a lower power mode at block 502. For example, if sensor data from the refueling sensors 202 proximate the neck inlet 304 will be relied upon to determine whether refueling is taking place, those refueling sensors 202 may remain in a higher power mode, while the rest of the refueling sensors 202 are put into a lower power mode at block 502.

At block 506, the refueling detection process 500 determines whether sensor data from the refueling sensors 202 (or other data) indicates that refueling is taking place. If not, the refueling detection process 500 returns to block 504. On the other hand, if sensor data from the refueling sensors 202 does indicate that refueling is taking place, the refueling detection process 500 proceeds to block 508, where the refueling detection system 200 is put into a higher power mode, as discussed above. In some examples, blocks 502-508 may be omitted or skipped, such as, for example, if there are only a few refueling sensors 202, if the refueling sensors 202 use minimal power, and/or if the energy storage device 152 has such a robust storage of energy that depletion is of minimal concern.

In the example of FIG. 5, the refueling detection process 500 obtains sensor data from (e.g., all of) the refueling sensors 202 at block 510, and thereafter determines the level and/or volume of fuel 302 in the fuel tank 300 based on the sensor data at block 512. At block 514, the refueling detection process 500 then provides one or more operator perceptible outputs via the refueling output device(s) 204. In some examples, the perceptible output may be a visual output in the visible light spectrum that will be visible to a human operator, an audible output within an acoustic range that will be audible to a human operator (e.g., 20 Hz to 20 kHz, 2 kHz to 5 kHz, 0 dB to 120 dB, 50 dB to 85 dB, etc.), and/or a haptic output that will be felt by a human operator.

At block 516, the refueling detection process 500 determines whether one or more fuel level/volume thresholds have been reached. In some examples, the determination may be made based on the fuel level/volume determination at block 512.

In some examples, the fuel level/volume threshold(s) may be stored in memory circuitry 208. For example, a threshold may be representative of a fuel level/volume where the fuel tank 300 is has been filled almost to the top, with some room remaining for expansion of fuel 302 without overflow. As another example, a threshold may be representative of a volume/level of fuel 302 where the fuel tank 300 has almost been filled to the top, so that the operator knows that refueling is almost complete.

At block 518, the refueling detection process 500 provides one or more operator perceptible outputs indicating that a particular threshold has been reached via the refueling output device(s) 204. In some examples, the output(s) at block 518 may be different than the output(s) at block 514. For example, the refueling detection process 500 may output a visible fuel gauge that shows the volume/level of fuel 302 rising at block 512, and output an audible tone at block 518 to indicate that the fuel tank 300 is full, or almost full. As another example, the refueling detection process 500 may output a simple blinking light at block 514 to indicate the level/volume of fuel 302 is rising, and output a solid light at block 516 to indicate that the fuel tank 300 is full. In some examples, block 514 may be omitted, and an output only provided when a threshold is reached (at block 518), which may, for example, save on the amount of stored energy used by the refueling detection system.

In the example of FIG. 5, the refueling detection process 500 determines whether a threshold (e.g., stored) amount of time has passed since reaching the threshold(s) level(s)/volume(s) of fuel 302 at block 520. If the amount of time has not passed, the refueling detection process 500 returns to block 510. If the threshold amount of time has passed, the refueling detection process 500 returns to block 502, where the refueling detection system 200 is once again put into the lower power mode.

The disclosed refueling detection system 200 provides user perceptible outputs from refueling output devices 204 positioned proximate the fuel tank 300 (and/or fuel tank inlet 304), so that the output can be perceived by the operator when refueling. The outputs may indicate how much fuel 302 is in the fuel tank 300, and/or whether the fuel tank 300 has been filled to capacity, so the operator knows when to stop refueling. The refueling detection system 200 is additionally configured to operate even when the power supply 102 is turned off, in case the power supply 102 is turned off prior to refueling (as is the best practice).

The present methods and/or systems may be realized in hardware, software, or a combination of hardware and software. The present methods and/or systems may be realized in a centralized fashion in at least one computing system, or in a distributed fashion where different elements are spread across several interconnected computing or cloud systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As utilized herein, the terms “e.g.,” and “for example” set off lists of one or more non-limiting examples, instances, or illustrations.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

As used herein, a control circuit may include digital and/or analog circuitry, discrete and/or integrated circuitry, microprocessors, DSPs, etc., software, hardware and/or firmware, located on one or more boards, that form part or all of a controller, and/or are used to control a welding process, and/or a device such as a power source or wire feeder.

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory device.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory can be configured to store code, instructions, applications, software, firmware and/or data, and may be external, internal, or both with respect to the processor.

The term “power” is used throughout this specification for convenience, but also includes related measures such as energy, current, voltage, and enthalpy. For example, controlling “power” may involve controlling voltage, current, energy, and/or enthalpy, and/or controlling based on “power” may involve controlling based on voltage, current, energy, and/or enthalpy.

As used herein, welding-type refers to actual live, and/or simulated, welding (including laser welding and/or hot wire welding), cladding (including laser cladding), brazing, plasma cutting, induction heating, carbon arc cutting or gouging, hot wire preheating, and/or resistive preheating.

As used herein, a welding-type tool refers to a tool suitable for and/or capable of actual live, and/or simulated, welding (including laser welding and/or hot wire welding), cladding (including laser cladding), brazing, plasma cutting, induction heating, carbon arc cutting or gouging, hot wire preheating, and/or resistive preheating.

As used herein, welding-type power refers to power suitable for actual live welding (including laser welding and/or hot wire welding), cladding (including laser cladding), brazing, plasma cutting, induction heating, carbon arc cutting or gouging, hot wire preheating, and/or resistive preheating.

As used herein, a welding-type power supply and/or welding-type power source refers to a device capable of, when input power is applied thereto, supplying output power suitable for actual live welding (including laser welding and/or hot wire welding), cladding (including laser cladding), brazing, plasma cutting, induction heating, carbon arc cutting or gouging, hot wire preheating, and/or resistive preheating; including but not limited to transformer-rectifiers, inverters, converters, resonant power supplies, quasi-resonant power supplies, switch-mode power supplies, etc., as well as control circuitry and other ancillary circuitry associated therewith.

As used herein, disable may mean deactivate, incapacitate, and/or make inoperative. As used herein, enable may mean activate and/or make operational.

Disabling of circuitry, actuators, and/or other hardware may be done via hardware, software (including firmware), or a combination of hardware and software, and may include physical disconnection, de-energization, and/or a software control that restricts commands from being implemented to activate the circuitry, actuators, and/or other hardware. Similarly, enabling of circuitry, actuators, and/or other hardware may be done via hardware, software (including firmware), or a combination of hardware and software, using the same mechanisms used for disabling.

What is claimed is:

1. An engine driven power supply, comprising:
a fuel tank configured to store a volume of fuel;
an engine-generator configured to use the fuel stored in the fuel tank to generate electrical power;
an energy storage device configured to output stored power;
a refueling detection system that receives the stored power from the energy storage device even when the engine driven power supply is powered off, the powered off refueling detection system comprising:
a fuel level sensor configured to detect fuel level sensor data indicative of the volume of the fuel within the fuel tank,
control circuitry configured to receive the fuel level sensor data from the fuel level sensor, and determine the volume of the fuel in the fuel tank based on the fuel level sensor data, and
an output device configured to provide a perceptible output indicative of the volume of the fuel in the fuel tank.

2. The engine driven power supply of claim 1, wherein the fuel level sensor is configured to operate in a lower power mode, where the fuel level sensor data is detected at a lower sampling rate, and the fuel level sensor is configured to switch to operation in a higher power mode, where the fuel level sensor data is detected at a higher sampling rate, in response to being activated by the control circuitry.

3. The engine driven power supply of claim 2, wherein the control circuitry is configured to activate the fuel level sensor in response to determining, based on the fuel level sensor data, that that fuel tank is being refueled.

4. The engine driven power supply of claim 2, wherein the refueling detection system further comprises a refueling sensor configured to detect when the fuel tank is being refueled, the control circuitry being configured to activate the fuel level sensor in response to the refueling sensor detecting the fuel tank is being refueled.

5. The engine driven power supply of claim 2, wherein the fuel level sensor is configured to return to operation in the lower power mode a threshold time period after the control circuitry determines that (i) the fuel tank is no longer being refueled, or (ii) the volume of the fuel within the fuel tank has reached a threshold level.

6. The engine driven power supply of claim 1, wherein (i) the fuel level sensor comprises an optical sensor, a float sensor, a moisture sensor, an acoustic sensor, a depth sensor, a distance sensor, weight sensor, or a proximity sensor, (ii) the fuel level sensor is positioned in or on a neck of the fuel tank, or (iii) the output device is configured to provide the perceptible output in response to the volume of the fuel in the fuel tank reaching a threshold level.

7. The engine driven power supply of claim 1, wherein the output device comprises a first output device, the engine driven power supply further comprising a second output device comprising an electrical fuel gauge, the second output device receiving stored power from the energy storage device only when the engine driven power supply is powered on.

8. The engine driven welding power supply of claim 7, further comprising a housing enclosing the power conversion circuitry and the energy storage device, the housing comprising a front panel, a rear panel, and a side panel connecting the front and rear panel, the second output device being positioned on or in the front panel of the housing, and the first output device not being positioned on or in the front panel of the housing.

9. The engine driven welding power supply of claim 7, wherein the second output device is part of a circuit that comprises the second output device, the energy storage device, and a power switch.

10. The engine driven welding power supply of claim 9, further comprising a power switch interface configured to receive user input, and open or close the power switch in response to the user input, wherein the circuit is complete, and the second output device is powered by the stored power, when the power switch is closed, and the circuit is broken, and the second output device is unpowered, when the power switch is open.

11. An engine driven welding-type power supply, comprising:
a fuel tank configured to store a volume of fuel;
an engine-generator configured to use the fuel stored in the fuel tank to generate electrical power;
power conversion circuitry configured to receive the electrical power from the generator as input power and convert the input power to welding-type output power based on one or more control signals;
an energy storage device configured to output stored power;
a refueling detection system that receives the stored power from the energy storage device even when the engine driven power supply is powered off, the powered off refueling detection system comprising:
a fuel level sensor configured to detect fuel level sensor data indicative of the volume of the fuel within the fuel tank,
control circuitry configured to receive the fuel level sensor data from the fuel level sensor, and determine the volume of the fuel in the fuel tank based on the fuel level sensor data, and
an output device configured to provide a perceptible output indicative of the volume of the fuel in the fuel tank.

12. The engine driven welding-type power supply of claim 11, wherein the fuel level sensor is configured to operate in a lower power mode, where the fuel level sensor data is detected at a lower sampling rate, and the fuel level sensor is configured to switch to operation in a higher power mode, where the fuel level sensor data is detected at a higher sampling rate, in response to being activated by the control circuitry.

13. The engine driven welding-type power supply of claim 12, wherein the control circuitry is configured to activate the fuel level sensor in response to determining, based on the fuel level sensor data, that that fuel tank is being refueled.

14. The engine driven welding-type power supply of claim 12, wherein the refueling detection system further comprises a refueling sensor configured to detect when the fuel tank is being refueled, the control circuitry being configured to activate the fuel level sensor in response to the refueling sensor detecting the fuel tank is being refueled.

15. The engine driven welding-type power supply of claim 12, wherein the fuel level sensor is configured to return to operation in the lower power mode a threshold time period after the control circuitry determines that (i) the fuel tank is no longer being refueled, or (ii) the volume of the fuel within the fuel tank has reached a threshold level.

16. The engine driven welding-type power supply of claim 11, wherein (i) the fuel level sensor comprises an optical sensor, a float sensor, a moisture sensor, an acoustic sensor, a depth sensor, a distance sensor, weight sensor, or a proximity sensor, (ii) the fuel level sensor is positioned in or on a neck of the fuel tank, or (iii) the output device is configured to provide the perceptible output in response to the volume of the fuel in the fuel tank reaching a threshold level.

17. The engine driven welding-type power supply of claim 11, wherein the output device comprises a first output device, the engine driven power supply further comprising a second output device comprising an electrical fuel gauge, the second output device receiving stored power from the energy storage device only when the engine driven power supply is powered on.

18. The engine driven welding-type power supply of claim 17, further comprising an electrical socket and a housing, the electrical socket being in electrical communication with the power conversion circuitry and configured for connection with an electrical cable that will route the output power to a welding-type tool or welding-type equipment, the housing enclosing the power conversion circuitry and the energy storage device, the housing comprising a front panel, a rear panel, and a side panel connecting the front and rear panel, the electrical socket and the second output device being positioned on or in the front panel of the housing, and the first output device not being positioned on or in the front panel of the housing.

19. The engine driven welding-type power supply of claim 17, wherein the second output device is part of a circuit that comprises the second output device, the energy storage device, and a power switch.

20. The engine driven welding-type power supply of claim 19, further comprising a power switch interface configured to receive user input, and open or close the power switch in response to the user input, wherein the circuit is complete, and the second output device is powered by the stored power, when the power switch is closed, and the circuit is broken, and the second output device is unpowered, when the power switch is open.
